(19) United States
(12) Patent Application Publication
(10) Pub. No.: US 2002/0140628 A1
(43) Pub. Date: Oct. 3, 2002

(54) Computer addition

(76) Inventor: James Vincent Morrone, Old Town, ME (US)

Correspondence Address: Mr. JAMES MORRONE, LAFAYETTE STATION, P.O. BOX 26, BOSTON, MA, 02112, US

(21) Appl. No.: 10/154,352

(22) Filed: May 23, 2002

Related U.S. Application Data
(63) Continuation of application No. 08/514,561, filed on Aug. 14, 1995, now abandoned.
(63) Continuation of application No. 09/024,784, filed on Feb. 17, 1998, now abandoned.
(63) Continuation of application No. 09/264,403, filed on Mar. 8, 1999.

(51) Int. Cl. G09G 5/00

(52) U.S. Cl. 345/1.1

(57) ABSTRACT

Additional multiple screening for a computer and comprising a hinge means connected to the primary viewing monitor and further connected to the additional screening. The hinge means allowing the additional screening to pivot to a forward position or to pivot to a rearward position relative to the primary monitor. The hinge means further allowing the additional screening to be folded back to the sides of the monitor so as to be out-of-the-way while the additional screening is not in use.

The primary monitor receiving imaging or wording transmission from or through the computer, the additional screening to be used for receiving imaging or wording from or through the computer or primary monitor, or both.

### RELATED APPLICATION

This application is a continuation of the following earlier filed and copending application on related subject matter:

Ser. No. 08/514,561, Filed: Aug. 14, 1995, and now abandoned.

Ser. No. 09/024,784, Filed: Feb. 17, 1998, and now abandoned.

Ser. No. 09/264,403, Filed: Mar. 8, 1999, and now pending.

### BACKGROUND OF THE INVENTION

The present invention is designed in particular for but not limited to multiple viewing screening for computers.

The common computer has only one viewing screen used for viewing imaging or wording, this viewing screen is referred to as a monitor.

Many times the operator, user of the computer has to refer to other imaging or wording which is stored in the computer memory system and which is not on the monitor viewing screen at the time the user is viewing the present screen, thus the operator has to remove, cancel the present imaging or wording from the viewing screen in order to bring other previously stored matter to the screen. This often creates undesirable manipulation replacing one screen for another and confusion often results.

Therefore, it would be ideal and to the users advantage to have additional viewing screens to refer to while the operator is viewing the primary monitor screen,

therefore it is the object of the present invention to prepare for future computer operations by providing additional viewing screens for computers which may be used with existing or with future computer electronics.

The invention being claimed is not however the electronics of the computer, but additional screening which may be used, added to the left, right or both sides of the primary monitor screen and receive transmission from the computer through a wire or any means suitable for this transmission. It is certainly belived that present technology in electronics already exist which will preform this function. A good example of this is for instance, bringing into view on a presently existing common computer screen a seperate window or seperate image while still viewing what was originally on the screen. This may be done by moving the original material over and allowing room for the seperate window or image to be put on the same screen in the provided space.

Therefore, it is the object of the present invention to simply use another screen for showing the seperate window or image or wording by transferring the same to the additional screening instead of showing it on the primary monitor screen. It is understood however that windows or seperate imaging or wording may still be used with the additional screening if so desired.

A further object of the present invention is to provide understanding for preforming the function of using additional screening. This would be done by having a menu to choose from which will show a selection display for using screen 1, 2 or 3, or all simultaneously. The menu will also show a display for cancelling any screen. The menu will further show a selection display for recalling to screen 1, 2 or 3 matter already stored in the computer memory system or to cancel stored matter from the memory system in either screen. This would be done by clicking-on, recalling a desired screen either to the left, right or center primary screen and holding, maintaining that desired screen in view and programing the computer to store or cancel memory on that particular screen.

A further object of the present invention is to provide hinge means for additional screening, allowing the screening to pivot to a forward position or to a rearward position from the primary viewing monitor, the hinge means further allowing the additional screening to be folded back to the sides of the viewing monitor, computer so as to be out-of-the-way while not in use. It is understood that the additional screening is narrow in thickness allowing the screening to fold back compactly to the side or sides of the monitor.

### SUMMARY OF THE INVENTION

Therefore, there are provided additional viewing screens for the computer. These additional screens may be located to the left, right or both sides of the main primary screen. The operator may, while viewing the primary screen, click-on recall a previously stored portion of memory from the computer memory system and show that portion on another screen, the additional screens having been made ready to receive transmission, and while still maintaining viewing of the primary screen the operator may use another screen to add, store or cancel memory to or from the computer memory system.

### BRIEF DESCRIPTION OF THE DRAWINGS

FIG. 1 is a simulated front view of a computer and also illustrating multiple viewing screens. FIG. 1 also illustrates a simulated prespective view of the computer keyboard and mouse.

### DETAILED DESCRIPTION OF THE DRAWINGS

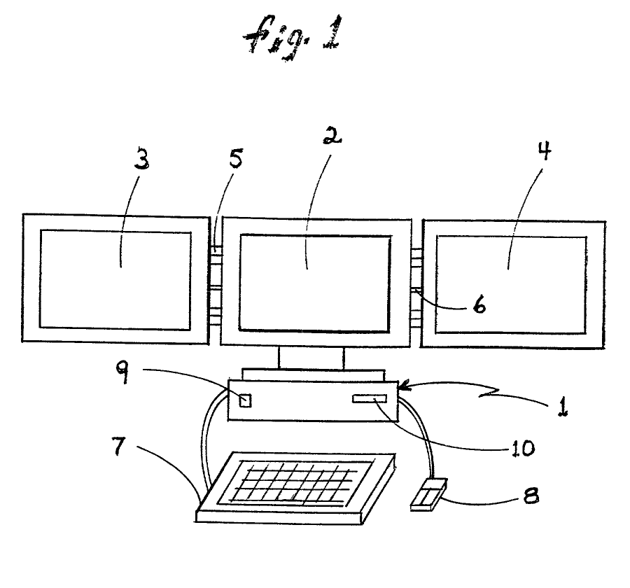

FIG. 1 illustrates a computer 1 comprising a primary monitor viewing screen 2, a keyboard 7, a computer mouse 8. The computer has a power button 9 for allowing power to enter the computer, a slot 10 for receiving discs. The slot may be of the type for receiving a storage case with the disc inside, such as a “C.D.ROM”, or the slot may be of the type for receiving a disc with-out a storage case. FIG. 1 further shows additional multiple viewing screens 3 and 4 located to the left and right of the primary screen 2, a wire 6 is shown to be used for allowing transmission from or through the computer, or from or through the primary monitor, or both. The transmission bringing imaging or wording, or both into view on the multiple screening. The multiple screening is connected to the primary viewing screen monitor by a hinge means 5 which allows either additional screen to pivot forward or rearward, and further allows the additional screening to be folded back to the sides of the monitor so as to be out-of-the-way while not in use, if so desired.

What is claimed is:

1. A primary viewing screen to be used for electronic transmission for viewing imaging or wording thereon,
in combination with additional viewing screens designed in particular for and also to be used for viewing imaging or wording thereon,
said additional viewing screens connected to both left and right sides of said primary viewing screen,
and employing means allowing pivoting of said additional viewing screens to a forward or to a rearward position relative to the primary viewing screen.

2. A computer comprising a primary monitor viewing screen for viewing imaging or wording transmission from or through said computer,
in combination with additional viewing screens designed in particular for and also to be used for viewing imaging or wording,
said additional viewing screens receiving said imaging or wording from or through said computer or monitor or from or through both said computer and monitor,
said additional viewing screens connected to both left and right sides of said primary monitor.

3. A primary viewing screen to be used for electronic transmission for viewing imaging or wording thereon,
in combination with additional viewing screens, designed in particular for connection to said primary viewing screen,
said additional viewing screens also utilized for viewing imaging or wording thereon,
said primary viewing screen and said additional viewing screens to be used for necessary required electronics, that said screening be made ready for use,
said primary viewing screen having it's own seperate physical body in relation to said additional viewing screens having their own seperate physical bodies,
said additional viewing screens physical bodies seperated from said primary viewing screen physical body
but partially connected to the primary screen by a connecting means,
said connecting means also aiding in maintaining said physical seperation,
said connecting means connected to the primary viewing screen and further connected to the additional viewing screens and employing features which allow said connecting means to require being connected together for the purpose of stabilization of said additional screens to said primary screen,
said connecting means further allowing said additional viewing screens to adapt to a forward or to adapt to a rearward position relative to the primary viewing screen.

4. A primary viewing screen to be used for electronic transmission as set forth in claim 1,
wherein said additional viewing screens employ a hinge-type means for allowing said pivoting.

5. A primary viewing screen as set forth in claim 3, wherein said additional viewing screens are located on the left and right sides of said primary viewing screen.

6. A primary viewing screen to be used for electronic transmission for viewing imaging or wording thereon,
in combination with additional viewing screens, designed in particular for connection to said primary viewing screen,
said additional viewing screens also utilized for viewing imaging or wording thereon,
said primary viewing screen and said additional viewing screens to be used for necessary required electronics, that said screening be made ready for use,
said primary viewing screen having it's own seperate physical body in relation to said additional viewing screens having their own seperate physical bodies,
said additional viewing screens physical bodies seperated from said primary viewing screen physical body
but partially connected to the primary screen by a connecting means,
said connecting means also aiding in maintaining said physical separation,
said connecting means connected to the primary viewing screen and further connected to the additional viewing screens and employing features which allow said connecting means to require being connected together for the purpose of stabilization of said additional screens to said primary screen,
said connecting means further allowing said additional viewing screens to adapt to a forward or to adapt to a rearward position relative to the primary viewing screen,
said adaption to forward or rearward position may be brought to a full ninty degrees in either direction.

7. Double viewing screens to be used for electronic transmission for viewing imaging or wording thereon,
said double viewing screens are provided so as to be used for necessary required electronics
that said double viewing screens be made ready for use,
said double viewing screens may be used for simultaneous viewing imaging or wording or both on one screen and different imaging or wording or both on the other screen,
said double viewing screens designed in particular for direct connection one screen connected to the other,
said double viewing screens requiring no other means for said direct connection,
said double viewing screens designed to remain permanently connected one to the other,
said double viewing screens having each it's own seperate physical body
but partially connected together by hinge type connecting means,
said hinge type connecting means utilized for said direct connection,
said hinge type connecting means also aiding in maintaining said each it's own seperate physical body one from the other
and while said viewing screens are in use said physical bodies are seperated one from the other by virtue of said hinge type connecting means being located therebetween,
said hinge type connecting means also employing features which allow said connecting means to require being connected together for the purpose of stabilization of said double viewing screens,
said hinge type connecting means also allowing said double viewing screens to pivotally adapt
one viewing screen away from the other
to at least a full ninty degrees position away
and while maintaining said direct connection
one screen to the other.

8. Triple viewing screens to be used for electronic transmission for viewing imaging or wording thereon,
said triple viewing screens are provided so as to be used for necessary required electronics
that said triple viewing screens be made ready for use,
said triple viewing screens designed in particular for direct connection each screen connected to the other,
said triple viewing screens requiring no other means for said direct connection,
said triple viewing screens designed to remain permanently connected each to the other,
said triple viewing screens location a middle screen a screen directly connected to the left side of said middle screen a screen directly connected to the right side of said middle screen,
said triple viewing screens having each it's own seperate physical body
but partially connected together by hinge type connecting means,
said hinge type connecting means utilized for said direct connection,
said hinge type connecting means also aiding in maintaining said each it's own seperate physical body one from the other
and while said viewing screens are in use said physical bodies are seperated one from the other by virtue of said hinge type connecting means being located therebetween,
said hinge type connecting means also employing features which allow said connecting means to require being connected together for the purpose of stabilization of said triple viewing screens,
said triple viewing screens may be used for viewing different imaging or wording or both on all three screens at the same time,
said hinge type connecting means also allowing said viewing screens to pivotally adapt
the left screen away from the middle screen
to at least a full ninty degrees position away
the right screen away from the middle screen
to at least a full ninty degrees position away
and while maintaining said direct connection one screen to the other.

9. Triple viewing screens to be used for electronic transmission for viewing imaging or wording thereon,
said triple viewing screens are provided so as to be used for necessary required electronics
that said triple viewing screens be made ready for use,
said triple viewing screens designed in particular for direct connection each screen connected to the other,
said triple viewing screens requiring no other means for said direct connection,
said triple viewing screens designed to remain permanently connected each to the other,
said triple viewing screens location a middle screen a screen directly connected to the left side of said middle screen a screen directly connected to the right side of said middle screen,
said triple viewing screens having each it's own seperate physical body
but partially connected together by hinge type connecting means,
said hinge type connecting means utilized for said direct connection,
said hinge type connecting means also aiding in maintaining said each it's own seperate physical body one from the other
and while said viewing screens are in use said physical bodies are seperated one from the other by virtue of said hinge type connecting means being located therebetween,
said hinge type connecting means also employing features which allow said connecting means to require being connected together for the purpose of stabilization of said triple viewing screens,
said triple viewing screens may be used for viewing different imaging or wording or both on all three screens at the same time,
said hinge type connecting means also allowing said viewing screens to pivotally adapt
the left or right screen away from the middle screen to a front or rearward direction
to at least a full ninty degrees position away in either direction
and while maintaining said direct connection one screen to the other.
